(19) United States
(12) Patent Application Publication
(10) Pub. No.: US 2024/0288626 A1
(43) Pub. Date: Aug. 29, 2024

(54) WAVELENGTH SHIFTING FIBER AND A METHOD OF MAKING THE SAME

(71) Applicant: Luxium Solutions, LLC, Hiram, OH (US)

(72) Inventors: Peter R. MENGE, Novelty, OH (US); Michael R. KUSNER, Auburn Township, OH (US); Fang MENG, Aurora, OH (US); Steven R. BOSLEY, Warren, OH (US)

(21) Appl. No.: 18/590,405

(22) Filed: Feb. 28, 2024

Related U.S. Application Data
(60) Provisional application No. 63/487,482, filed on Feb. 28, 2023.

(51) Int. Cl. G02B 6/02; G01T 1/20; G02B 6/42

(52) U.S. Cl. CPC G02B 6/02033; G02B 6/4215; G01T 1/20185

(57) ABSTRACT

A wavelength shifting fiber and method of making the same is disclosed. A wavelength shifting fiber can include a plastic core; and a coating surrounding the plastic core. The wavelength shifting fiber has an optical attenuation length of at least 500 cm. A method of making a wavelength shifting fiber can include storing a plastic core precursor and cladding melt preform in an environment containing an inert gas; and drawing the plastic core precursor and cladding melt preform to form a wavelength shifting fiber, wherein drawing is performed under tension of less than 77 g/mm² and more than 40 g/mm², and where the wavelength shifting fiber comprises an attenuation length of at least 500 cm.

### CROSS-REFERENCE TO RELATED APPLICATION(S)

This application claims priority under 35 U.S.C. § 119(e) to U.S. Provisional Patent Application No. 63/487,482, filed Feb. 28, 2023, by Peter R. MENGE et al., entitled “WAVELENGTH SHIFTING FIBER AND A METHOD OF MAKING THE SAME,” which is assigned to the current assignee hereof and incorporated herein by reference in its entirety for all purposes.

### FIELD OF THE DISCLOSURE

The present disclosure is directed to scintillating articles and methods of forming the same, and more particularly to wavelength shifting fibers with an optical waveguide.

### BACKGROUND

Radiation detection apparatuses are used in a variety of applications. For example, scintillators can be used for medical imaging and for well logging in the oil and gas industry as well for the environment monitoring, security applications, and for nuclear physics analysis and applications. Manufacturing wavelength shifting fibers has traditionally been limited by the properties of the materials used and thus can be quite challenging. Further improvements for manufacturing wavelength shifting fibers are desired.

### BRIEF DESCRIPTION OF THE DRAWINGS

Embodiments are illustrated by way of example and are not limited in the accompanying figures.

FIG. 1 shows an illustration of cross-sectional view of a plastic wavelength shifting fiber in accordance with one embodiment.

FIG. 2 shows a method of manufacturing a wavelength shifting fiber in accordance with one embodiment.

FIG. 3 includes an illustration of an end view of an article that includes a body and wavelength shifting fiber in accordance with still another embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, group numbers corresponding to columns within the Periodic Table of the elements use the “New Notation” convention as seen in the CRC Handbook of Chemistry and Physics, 81^{st} Edition (2000-2001).

An optical attenuation length of a wavelength shifting fiber characterizes and relates directly to the quantity of detectable light at the end of the fiber. The optical attenuation length is measured on an optical bench that holds and supports a wavelength shifting fiber. The optical bench includes a rail onto which are mounted: (1) a UV-Vis photodiode; (2) an excitation cavity; and (3) a mechanical holder to support the back end of the fiber. The front end of the wavelength shifting fiber is attached to a UV-Vis photodiode. The excitation cavity uses uniformly spaced 390 nm LEDs and a phototransistor to measure the strength of the excitation light. The cavity is mounted on a carriage which moves on the optical rail. The position of the carriage can be read on a scale attached to the optical bench rail with a precision of better than +5 mm. Details of the setup and operation of the optical bench are described in CERN (European Organization for Nuclear Research) publication LHCb-PUB-2015-011 which is titled “A set-up to measure the optical attenuation length of scintillating fibers” and was published on May 12, 2015.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

A wavelength shifting fiber can include a plastic core and a coating surrounding the plastic core to improve transmission of light along the fiber, and ultimately increase the amount of light that can reach a radiation detector containing the wavelength shifting fiber.

In an embodiment, the wavelength shifting fiber may contain a polymerized, solid plastic scintillation core and a cladding surrounding the core with an attenuation length greater than 500 cm. Long attenuation lengths have been plagued with micro-factures on the surface of the core that causes light to scatter. However, longer attenuation lengths with less micro-fractures leads to more light being detected in a detector. By containing more light within the core, the wavelength shifting fiber enables more light to ultimately reach a detector, enhancing output. A long attenuation length is difficult to obtain. Attenuation length is a measure of how much light makes the trip from beginning to end as it travels axially through the fiber. In fibers light may be lost by being absorbed or by being scattered out of the fiber. The inventors discovered that micro-fractures on the surface of the core that arise during manufacturing greatly reduce the attenuation length of the fiber and cause scattering points to arise. It was thought that factors affecting micro-factures could include defects on the preform surface, combination of thermal contraction with elongation strain, differences in rheology between the hot inside and cool outside causing axial shear stress, and tensile stress caused by the weight of the fiber as the length increased. By reducing the number and severity of the micro-fractures on the surface of the core, the attenuation length can vastly increase.

Moreover, materials selected for the core and the cladding have traditionally been limited as both need to have similar melting points and thermal properties to be drawn at the same time. The selection of a particular cladding may depend on the particular scintillation properties that are desired. Additionally, contaminants—such as lubricating aids or dust particles—interfere with the transmission of photons along the length of the fiber, further adding to the loss of light. As used in this specification, a cladding can include two or more different elements or layers.

Any of the wavelength shifting fibers as described below can be used in a variety of applications. Exemplary applications include gamma ray spectroscopy, isotope identification, Single Photon Emission Computer Tomography (SPECT) or Positron Emission Tomography (PET) analysis, x-ray imaging, oil well-logging detectors, medical imaging devices, network communications device, high energy physics, small detectors, network communications, broadcast receivers, wireless transmissions, augmented reality devices, broadcasting networks, and detecting the presence of radioactivity. The wavelength shifting fiber can be used for other applications, and thus, the list is merely exemplary and not limiting. A couple of specific applications are described below.

Embodiments described below and illustrated are provided to aid in understand the concepts as set forth herein. The embodiments are merely illustrative and not intended to limit the scope of the present invention, as set forth in the appended claims.

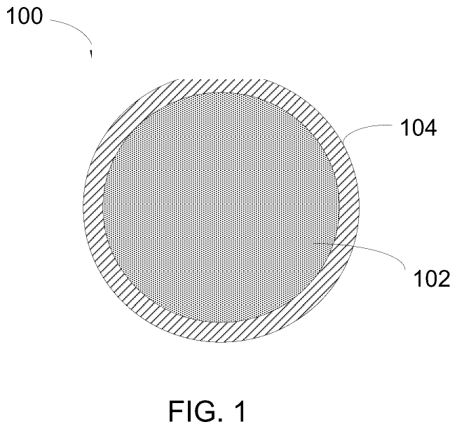

FIG. 1 shows an illustration of a plastic wavelength shifting fiber 100 in accordance with one embodiment. The plastic wavelength shifting fiber 100 can include a core 102 and a cladding 104. In one embodiment, the cladding 104 can be formed by coating and can thereby be referred to as a coating. In one embodiment, the core 102 can be a plastic core. The core 102 can include a material selected from the group consisting of polystyrene (PS), polyvinyltoluene (PVT), and polymethyl methacrylate (PMMA), polycarbonate, and any combination thereof. The core 102 may be various geometric shapes such as round, square, triangular, polygonal, or hexagonal. In one embodiment, the core 102 can contain fluorescent dopants selected to produce a desired scintillation characteristic. The core 102 may have a diameter of 0.01 mm to 5 mm. In one embodiment, the core 102 may have a diameter of at least 0.01 mm, such as a diameter of 0.1 mm, or a diameter of 0.2 mm, or a diameter of 0.5 mm, or a diameter of 1 mm, or a diameter of 2 mm. In one embodiment, the core 102 may have a diameter of at most 5 mm, such as at most 4.5 mm, or at most 4 mm, or at most 3.5 mm.

The coating 104 may surround the core 102. In one embodiment, the coating 104 may surround the entire core 102. In one embodiment, the coating 104 can be in direct contact with the core 102. In one embodiment, the coating 104 can be in direct contact with the core 102 without any intervening material, for example lubricants, in between. In one embodiment, the coating 104 can include a single layer. In another embodiment, the coating 104 can include at least two layers. In one embodiment, the at least two layers of the coating 104 can have different composition of materials. In another embodiment, the at least two layers of the coating 104 can be the same material. In yet another embodiment, the at least two layers of the coating 104 can be different materials. The coating 104 can include an organic material. In one embodiment, the coating 104 can include a material selected from glycerol ether acrylate, methacrylated polymer, fluoroacrylate, multifunctional acrylate, polyvinyltoluene (PVT), and polymethyl methacrylate (PMMA), polycarbonate or a combination thereof. In another embodiment, the coating 104 can include a dopant. In another embodiment, the coating 104 can include an additive to make the coating 104 more reflective.

In one embodiment, the coating 104 can have the same shape as the core 102. In another embodiment, the coating 104 can have a different shape from the core 102. For example, in one embodiment the core 102 may be circular and the coating 104 may be square. In one embodiment, the coating 104 can be an ultra violet cured coating. In one embodiment the coating 104 can have a thickness of between about 3 μm to about 1 mm. In one embodiment, the coating 104 can have a thickness of at least 3 μm, such as a thickness of 25 μm, or such as 50 μm, or such as 75 μm, or such as 100 μm, or such as 500 μm. In one embodiment, the coating 104 can have a thickness of at most 600 μm, such as a thickness of 700 μm, or such as 800 μm, or such as 1 mm. In one embodiment, the plastic fiber 100 can be a wavelength shifting fiber.

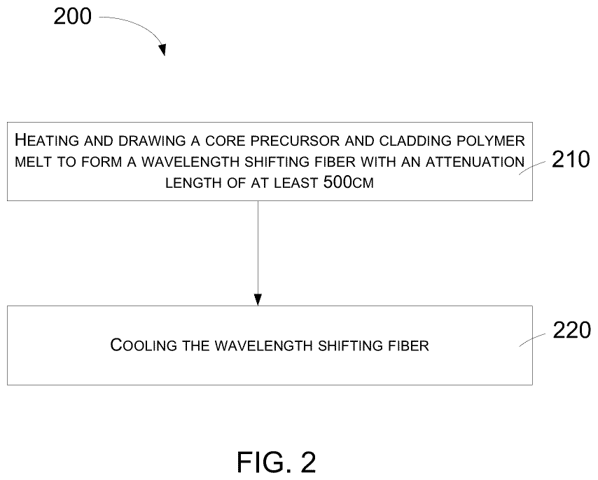

FIG. 2 shows a method 200 of manufacturing the wavelength shifting fiber 100 in accordance with one embodiment. In one embodiment, the wavelength shifting fiber 100 can be a scintillation fiber. In one embodiment, a mixture that can include a liquid monomer and scintillating additives is polymerized to form the core precursor. In one embodiment, the core precursor can be a plastic core precursor. In one embodiment, the core precursor can include a material selected from the group consisting of polystyrene (PS), polyvinyltoluene (PVT), and polymethyl methacrylate (PMMA), polycarbonate and any combination thereof. In one embodiment, the polymerization can be done in geometric shaping tubes. For example, in one embodiment, the polymerization can be done in a cylindrical tube to form a round scintillating core. In one embodiment, the core precursor can have a refractive index of less than 1.60, such as a refractive index of less than 1.59, or a refractive index of less than 1.57, or a refractive index of less than 1.55, or a refractive index of less than 1.50. In one embodiment, the core precursor can have a refractive index of greater than 0.2.

Before the preform is drawn out to form a core, the preform may be stored in a low oxygen environment, such as in a high vacuum environment, i.e., less than 1E-4 Torr, or in an environment containing inert gas. In one embodiment, the environment can contain less than 7E11 oxygen molecules/cc. In one embodiment, the preform can be stored for more than 6 days. In one embodiment, the starting material, or preform, may be stored in an environment containing argon gas. Storing the preform in an environment that prevents oxidation of the starting material can help prevent or reduce fractures on the surface of the core. In one embodiment, anti-oxidants can be added to the core precursor and/or cladding melt. In one embodiment, butylated hydroxytoluene can be added to the core precursor and/or cladding melt. In another embodiment, polymerization and plasticizing catalysts can be added to the core precursor and/or cladding melt. In one embodiment, dienes and/or esters can be added to the core precursor and/or cladding melt.

At operation 210, the core precursor, the cladding polymer melt, can be heated and fed under pressure and co-extruded or drawn out to form a fiber. In one embodiment, the core can be a plastic core. In one embodiment, the plastic core can be similar to core 102 described above. In one embodiment, the plastic core can have a diameter of greater than 8 mm, such as a diameter greater than 10 mm, or greater than 12 mm. In one embodiment, the plastic core precursor can have a larger diameter than the plastic core. In one embodiment, the core precursor and cladding melt can be heated to a temperature greater than 240° C., such as a temperature greater than 260° C., or greater than 270° C., or greater than 300° C. In one embodiment, the core precursor can be pulled at a rate of less than 150 g/mm², such as less than 140 g/mm², or such as less than 120 g/mm², or such as less than 100 g/mm². In one embodiment, the liquid coating can include a material selected from glycerol ether acrylate, methacrylated polymer, fluoroacrylate, multifunctional acrylate, or a combination thereof. In another embodiment, the liquid coating can include a dopant. In another embodiment, the liquid coating can include an additive to increase the reflectance of the liquid coating. In one embodiment, the liquid coating can have a melting point that is different from the core precursor. In one embodiment, the liquid coating can have a melting point that is at least 80 degrees Celsius higher than the melting point for the core precursor, such as a melting point that is at least 100 degrees Celsius higher than the melting point for the core precursor, or at least 150 degrees Celsius higher. In one embodiment, the liquid coating can have a melting point that is greater than 250° C., such as a melting point that is greater than 300° C., or greater than 350° C., or greater than 400° C., or greater than 500° C. In one embodiment, the liquid coating can have a refractive index of less than 1.50, such as a refractive index of less than 1.48, or a refractive index of less than 1.45, or refractive index of less than 1.42, or refractive index of less than 1.40, or refractive index of less than 1.35.

In one embodiment, the core precursor and cladding melt can be pulled under tension of less than 77 g/mm². In one embodiment, the core precursor and cladding melt can be pulled under tension of greater than 40 g/mm². In one embodiment, the core precursor can be and cladding melt pulled under tension of between 45 g/mm² and 60 g/mm². In one embodiment, the pulling speed can be between 2 m/min and 7 m/min, such as between 3 m/min and 6 m/min, or such as between 3 m/min and 5 m/min.

At operation 220, the fiber can be cooled using dry gas, such as dry air or nitrogen. Once cooled, the fiber can be a wavelength shifting fiber.

After the wavelength shifting fiber is formed, the wavelength shifting fiber may have an optical attenuation length of greater than 500 cm. In one embodiment, the wavelength shifting fiber may have an optical attenuation length of greater than 700 cm. In another embodiment, the wavelength shifting fiber may have an optical attenuation length of greater than 800 cm. The larger the attenuation length, the more light is able to be detected in a detector. By containing more light within the core, the wavelength shifting fiber enables more light to ultimately reach a detector, enhancing output. In one embodiment, the wavelength shifting fiber can have an optical attenuation length of less than 30 meters.

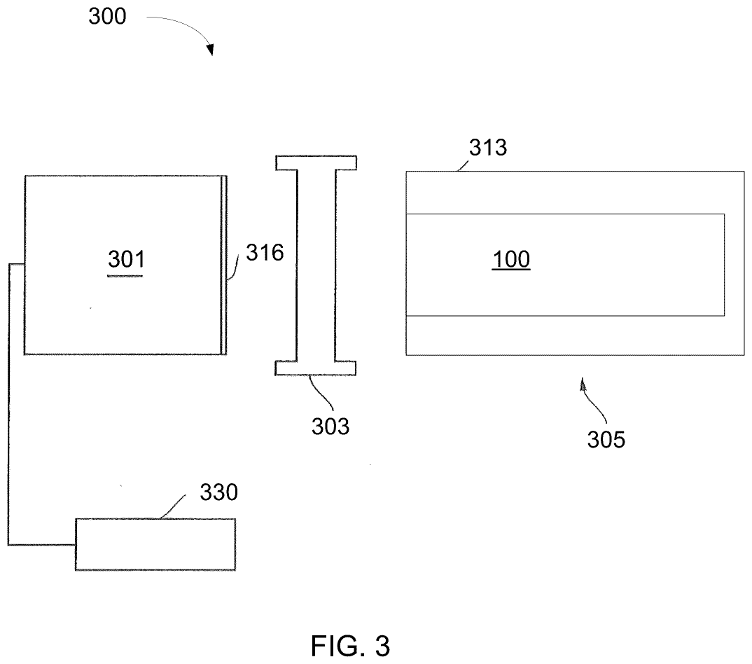

FIG. 3 illustrates an embodiment of a radiation detection apparatus 300 that can be used for gamma ray analysis, such as Single Photon Emission Computer Tomography (SPECT) or step-through X-ray machine. As shown in FIG. 3 and in accordance with embodiments described herein, the radiation detection apparatus 300 may include a photosensor 301, an optical interface 303, and a scintillation device 305. Although the photosensor 301, the optical interface 303, and the scintillation device 305 are illustrated in FIG. 3 as being separate from each other, it will be appreciated that, according to certain embodiments, photosensor 301 and the scintillation device 305 can be coupled to the optical interface 303, with the optical interface 303 disposed between the photosensor 301 and the scintillation device 305. According to still other embodiments, the scintillation device 300 and the photosensor 301 can be optically coupled to the optical interface 303 with other known coupling methods, such as the use of an optical gel or bonding agent, or directly through molecular adhesion of optically coupled elements.

According to yet other embodiments, the photosensor 301 may be a photomultiplier tube (PMT), a semiconductor-based photomultiplier, a hybrid photosensor, avalanche photodiodes, or a combination thereof. As used herein, a semiconductor-based photomultiplier in intended to mean a photomultiplier that includes a plurality of photodiodes, wherein each of the photodiodes have a cell size less than 1 mm, and the photodiodes are operated in Geiger mode. In practice, the semiconductor-based photomultiplier can include over a thousand photodiodes, wherein each photodiode has a cell size in a range of 10 microns to 100 microns and a fixed gain. The output of the semiconductor-based photomultiplier is the sum signal of all Geiger mode photodiodes. The semiconductor-based photomultiplier can include silicon photomultiplier (SiPM) or a photomultiplier based on another semiconductor material. For a higher temperature application (e.g., higher than 125° C.), the other semiconductor material can have a wider bandgap energy than silicon. An exemplary material can include SiC, a Ga-Group V compound (e.g., GaN, GaP, Ga₂O₃, or GaAs), or the like. An avalanche photodiode has a larger size, such as a light-receiving area of least 1 mm² and is operated in a proportional mode.

The photosensor 301 can receive photons emitted by the scintillation device 305, via an input window 316, and produce electrical pulses based on numbers of photons that it receives. The photosensor 301 is electrically coupled to an electronics module 330. The electrical pulses can be shaped, digitized, analyzed, or any combination thereof by the electronics module 330 to provide a count of the photons received at the photosensor 301 or other information. The electronics module 330 can include an amplifier, a pre-amplifier, a discriminator, an analog-to-digital signal converter, a photon counter, a pulse shape analyzer or discriminator, another electronic component, or any combination thereof. The photosensor 301 can be housed within a tube or housing made of a material capable of protecting the photosensor 301, the electronics module 330, or a combination thereof, such as a metal, metal alloy, other material, or any combination thereof.

The scintillation device 305 may include a wavelength shifting fiber as previously described, such as wavelength shifting fiber 100. The scintillation device 305 can be included within a larger system such as a gamma ray spectroscopy device, isotope identification device, Single Photon Emission Computer Tomography (SPECT) device, Positron Emission Tomography (PET) analysis device, x-ray imaging device, oil well-logging detectors, medical imaging devices, network communications device, small detectors, network communication devices, broadcast receivers, wireless transmissions devices, augmented reality devices, and broadcasting network systems. The wavelength shifting fiber 100 may be substantially surrounded by a casing 313. The scintillation device 305 may include at least one stabilization mechanism adapted to reduce relative movement between the wavelength shifting fiber 100 and other elements of the radiation detection apparatus 300, such as the optical interface 303, the casing 313, or any combination thereof.

The optical interface 303 may be adapted to be coupled between the photosensor 301 and the scintillation device 305. The optical interface 303 may also be adapted to facilitate optical coupling between the photosensor 301 and the scintillation device 305. The optical interface 303 can include a polymer, such as a silicone rubber, that is polarized to align the reflective indices of the wavelength shifting fiber 100 and the input window 316. In other embodiments, the optical interface 303 can include gels or colloids that include polymers and additional elements.

The concepts as described in this specification are not limited to the particular application previously described. The radiation detector can be configured for another type of radiation. Many different aspects and embodiments are possible. Some of those aspects and embodiments are described herein. Embodiments may be in accordance with any one or more of the embodiments as listed below.

Embodiment 1. A wavelength shifting fiber can include a plastic core and a coating surrounding the plastic core, where the wavelength shifting fiber can have an attenuation length of at least 500 cm.

Embodiment 2. The wavelength shifting fiber of Embodiment 1, where the optical attenuation length is at least 600 cm.

Embodiment 3. The wavelength shifting fiber of Embodiment 1, where the optical attenuation length is at least 700 cm.

Embodiment 4. The wavelength shifting fiber of Embodiment 1, where the optical attenuation length is at least 800 cm.

Embodiment 5. The wavelength shifting fiber of Embodiment 1, wherein the coating has a thickness of at least 3 μm, such as a thickness of 25 μm, or such as 50 μm, or such as 75 μm, or such as 100 μm, or such as 500 μm.

Embodiment 6. The wavelength shifting fiber of Embodiment 1, where the plastic core can include a material selected from the group consisting of polystyrene (PS), polyvinyltoluene (PVT), polymethyl methacrylate (PMMA), polycarbonate, and any combination thereof.

Embodiment 7. The wavelength shifting fiber of Embodiment 1, where the coating can include a material selected from the group consisting of glycerol ether acrylate, methacrylated polymer, fluoroacrylate, multifunctional acrylate, polyvinyltoluene (PVT), and polymethyl methacrylate (PMMA), polycarbonate and a combination thereof.

Embodiment 8. The wavelength shifting fiber of Embodiment 1, where the coating can include an organic material.

Embodiment 9. The wavelength shifting fiber of Embodiment 8, where the plastic core can include a fluorescent dopant.

Embodiment 10. The wavelength shifting fiber of Embodiment 1, where the plastic core can have a diameter of at least about 0.01 mm and not greater than about 5 mm.

Embodiment 11. The wavelength shifting fiber of Embodiment 1, where the core further comprises an anti-oxidant.

Embodiment 12. The wavelength shifting fiber of Embodiment 11, where the anti-oxidant is butylated hydroxytoluene.

Embodiment 13. A method of making a wavelength shifting fiber can include storing a preform in an environment containing an inert gas, heating and drawing a plastic core precursor and cladding melt to form a wavelength shifting fiber, where drawing is performed under tension of less than 77 g/mm² and more than 40 g/mm², and where the wavelength shifting fiber has an attenuation length of at least 500 cm.

Embodiment 14. The method of making a wavelength shifting fiber of Embodiment 13, where the plastic core can include a material selected from the group consisting of polystyrene (PS), polyvinyltoluene (PVT), polymethyl methacrylate (PMMA), polycarbonate, and any combination thereof.

Embodiment 15. The method of making a wavelength shifting fiber of Embodiment 13, where the plastic core precursor and cladding melt can be heated above 240° C.

Embodiment 16. The method of making a wavelength shifting fiber of Embodiment 13, where drawing can be performed at a rate of between 2 m/min and 7 m/min, such as between 3 m/min and 6 m/min, or such as between 3 m/min and 5 m/min.

Embodiment 17. The method of making a wavelength shifting fiber of Embodiment 13, where the core can include polystyrene and the cladding can include polymethyl methacrylate.

Embodiment 18. The method of making a wavelength shifting fiber of Embodiment 13, where the wavelength shifting fiber can include an attenuation length of at least 600 cm.

Embodiment 19. The method of making a wavelength shifting fiber of Embodiment 13, where the wavelength shifting fiber can include an attenuation length of at least 700 cm.

Embodiment 20. The method of making a wavelength shifting fiber of Embodiment 13, where the wavelength shifting fiber can include an attenuation length of at least 800 cm.

### Examples

Doped Polystyrene precursor rod and PMMA cladding were feed into 240° C. drawing oven at rate of 3 m/min and drawn into 1 mm fiber diameter under tension of less 60 g/mm². Fiber diameter was controlled using commercially available multi-axis laser diameter controller. The wavelength shifting fiber was measured to have an optical attenuation length of 556 cm.

Embodiments as described in this specification can allow for relatively large radiation detectors that can be used for inspecting cargo, vehicles, or other large objects, as well as research on high energy physics, medical imaging, small detectors, network communications, broadcast receivers, wireless transmissions, augmented reality devices, and broadcasting networks. Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A wavelength shifting fiber, comprising:
a plastic core; and
a coating surrounding the plastic core, wherein the wavelength shifting fiber has an optical attenuation length of at least 500 cm.

2. The wavelength shifting fiber of claim 1, wherein the optical attenuation length is at least 600 cm.

3. The wavelength shifting fiber of claim 1, wherein the optical attenuation length is at least 700 cm.

4. The wavelength shifting fiber of claim 1, where the optical attenuation length is at least 800 cm.

5. The wavelength shifting fiber of claim 1, wherein the coating has a thickness of at least 3 μm.

6. The wavelength shifting fiber of claim 1, where the plastic core comprises a material selected from the group consisting of polystyrene (PS), polyvinyltoluene (PVT), polymethyl methacrylate (PMMA), polycarbonate, and any combination thereof.

7. The wavelength shifting fiber of claim 1, wherein the coating comprises a material selected from the group consisting of glycerol ether acrylate, methacrylated polymer, fluoroacrylate, multifunctional acrylate, polyvinyltoluene (PVT), and polymethyl methacrylate (PMMA), polycarbonate and a combination thereof.

8. The wavelength shifting fiber of claim 1, wherein the coating can include an organic material.

9. The wavelength shifting fiber of claim 6, wherein the plastic core comprises a fluorescent dopant.

10. The wavelength shifting fiber of claim 1, wherein the plastic core can have a diameter of at least about 0.01 mm and not greater than about 5 mm.

11. The wavelength shifting fiber of claim 1, wherein the core further comprises an anti-oxidant.

12. The wavelength shifting fiber of claim 11, wherein the anti-oxidant is butylated hydroxytoluene.

13. A method of making a wavelength shifting fiber comprising:
storing a plastic core precursor and cladding melt preform in an environment containing an inert gas; and
drawing the plastic core precursor and cladding melt preform to form a wavelength shifting fiber, wherein drawing is performed under tension of less than 77 g/mm² and more than 40 g/mm², and wherein the wavelength shifting fiber comprises an attenuation length of at least 500 cm.

14. The method of making a wavelength shifting fiber of claim 13, wherein the plastic core can include a material selected from the group consisting of polystyrene (PS), polyvinyltoluene (PVT), polymethyl methacrylate (PMMA), polycarbonate, and any combination thereof.

15. The method of making a wavelength shifting fiber of claim 13, wherein the plastic core precursor and cladding melt are heated above 240° C.

16. The method of making a wavelength shifting fiber of claim 13, wherein drawing is performed at a rate of between 2 m/min and 7 m/min.

17. The method of making a wavelength shifting fiber of claim 13, wherein the core comprises polystyrene and the cladding comprises polymethyl methacrylate.

18. The method of making a wavelength shifting fiber of claim 13, wherein the wavelength shifting fiber comprises an attenuation length of at least 600 cm.

19. The method of making a wavelength shifting fiber of claim 13, wherein the wavelength shifting fiber comprises an attenuation length of at least 700 cm.

20. The method of making a wavelength shifting fiber of claim 13, wherein the wavelength shifting fiber comprises an attenuation length of at least 800 cm.
